(19) United States
(12) Patent Application Publication
(10) Pub. No.: US 2025/0249684 A1
(43) Pub. Date: Aug. 7, 2025

(54) LIQUID EJECTING APPARATUS, CONTROL METHOD OF LIQUID EJECTING APPARATUS AND MEDIUM STORING PROGRAM FOR LIQUID EJECTING APPARATUS

(71) Applicant: BROTHER KOGYO KABUSHIKI KAISHA, Nagoya (JP)

(72) Inventors: HIROYA OKUWA, Tajimi (JP); MIKIO HIRANO, Okazaki (JP); RUI WANG, Nagoya (JP); MOTOKI YAMADA, Nagoya (JP)

(21) Appl. No.: 19/042,255

(22) Filed: Jan. 31, 2025

(30) Foreign Application Priority Data
Feb. 2, 2024 (JP) 2024-015216

(51) Int. Cl. B41J 2/165; B41J 29/377

(52) U.S. Cl. CPC B41J 2/16538; B41J 2/16541; B41J 2/16544; B41J 29/377; B41J 2002/16573; B41P 2235/21

(57) ABSTRACT

A liquid ejecting apparatus includes: a head having a nozzle surface with a nozzle, and an actuator causing liquid to be ejected from the nozzle; a wiper; a cleaner; a first moving mechanism moving the nozzle surface and the wiper relatively; a second moving mechanism moving the wiper and the cleaner relatively; and a controller. The controller executes: a first ejecting process of ejecting the liquid from the nozzle to a medium; a wiping process of wiping the nozzle surface by driving the first moving mechanism to move the wiper and the nozzle surface relatively in a direction parallel to the nozzle surface with the wiper and the nozzle surface being in contact with each other; and a cleaning process of cleaning the wiper by driving the second moving mechanism to move the wiper and the cleaner relatively and bring the wiper and the cleaner into contact with each other.

### REFERENCE TO RELATED APPLICATIONS

This application claims priority from Japanese Patent Application No. 2024-015216 filed on Feb. 2, 2024. The entire content of the priority application is incorporated herein by reference.

### BACKGROUND ART

In a conventional liquid ejecting apparatus including a controller, a wiper, and a cleaning member (cleaner), the controller brings the cleaning member into contact with the wiper to thereby remove liquid adhered to the wiper.

### SUMMARY

In a case where the posture of the wiper is not held during a cleaning process, a problem that the cleaning is not performed properly might occur. In order to prevent this problem, such a configuration is considered that a holding mechanism which holds the posture of the wiper is included so as to hold the posture of the wiper during the cleaning process.

However, in a case where a pressing force from the cleaner to the wiper in a state that the posture of the wiper is held is greater than a pressing force from the cleaner to the wiper in a state that the posture of the wiper is not held, and where the posture of the wiper is always held during the cleaning process, the pressing force promotes the deterioration of the wiper.

An object of the present disclosure is to provide a liquid ejecting apparatus, a control method of the liquid ejecting apparatus, and a control program for the liquid ejecting apparatus each of which is capable of realizing both of proper cleaning of the wiper and prevention of the deterioration of the wiper.

A liquid ejecting apparatus according to the present disclosure includes: a head having a nozzle surface and an actuator, the nozzle surface having a nozzle opened therein, the actuator being configured to cause liquid to be ejected from the nozzle; a wiper; a cleaner; a first moving mechanism configured to move the nozzle surface and the wiper relatively; a second moving mechanism configured to move the wiper and the cleaner relatively; and a controller. The controller is configured to execute: a first ejecting process of ejecting the liquid from the nozzle to a recording medium by driving the actuator; a wiping process of wiping the nozzle surface by driving the first moving mechanism so as to move the wiper and the nozzle surface relatively in a direction parallel to the nozzle surface in a state that the wiper and the nozzle surface are brought into contact with each other; and a cleaning process of cleaning the wiper by driving the second moving mechanism so as to move the wiper and the cleaner relatively and bring the wiper and the cleaner into contact with each other. The liquid ejecting apparatus further includes a holding mechanism configured to hold a posture of the wiper during the cleaning process. A pressing force from the cleaner to the wiper in a case where the controller executes the cleaning process in a state that the holding mechanism holds the posture of the wiper is greater than a pressing force from the cleaner to the wiper in a case where the controller executes the cleaning process in a state that the holding mechanism does not hold the posture of the wiper. In a case where the controller executes the first ejecting process under a first condition, the controller is configured to execute the cleaning process in the state that the holding mechanism holds the posture of the wiper. In a case where the controller executes the first ejecting process under a second condition different from the first condition, the controller is configured to execute the cleaning process in the state that the holding mechanism does not hold the posture of the wiper.

A control method according to the present disclosure is a control method of a liquid ejecting apparatus including: a head having a nozzle surface and an actuator, the nozzle surface having a nozzle opened therein, the actuator being configured to cause liquid to be ejected from the nozzle; a wiper; a cleaner; a first moving mechanism configured to move the nozzle surface and the wiper relatively; and a second moving mechanism configured to move the wiper and the cleaner relatively. The control method includes: a first ejecting process of ejecting the liquid from the nozzle to a recording medium by driving the actuator; a wiping process of wiping the nozzle surface by driving the first moving mechanism so as to move the wiper and the nozzle surface relatively in a direction parallel to the nozzle surface in a state that the wiper and the nozzle surface are brought into contact with each other; and a cleaning process of cleaning the wiper by driving the second moving mechanism so as to move the wiper and the cleaner relatively and bring the wiper and the cleaner into contact with each other. The liquid ejecting apparatus further includes a holding mechanism configured to hold a posture of the wiper during the cleaning process. A pressing force from the cleaner to the wiper in a case where the cleaning process is being executed in a state that the holding mechanism holds the posture of the wiper is greater than a pressing force from the cleaner to the wiper in a case where the cleaning process is being executed in a state that the holding mechanism does not hold the posture of the wiper. In a case where the first ejecting process is executed under a first condition, the cleaning process is executed in the state that the holding mechanism holds the posture of the wiper. In a case where the first ejecting process is executed under a second condition different from the first condition, the cleaning process is executed in the state that the holding mechanism does not hold the posture of the wiper.

A non-transitory medium according to the present disclosure stores a program for a liquid ejecting apparatus. The liquid ejecting apparatus includes: a head having a nozzle surface and an actuator, the nozzle surface having a nozzle opened therein, the actuator being configured to cause liquid to be ejected from the nozzle; a wiper; a cleaner; a first moving mechanism configured to move the nozzle surface and the wiper relatively; and a second moving mechanism configured to move the wiper and the cleaner relatively. The program causes the liquid ejecting apparatus to execute: a first ejecting process of ejecting the liquid from the nozzle to a recording medium by driving the actuator; a wiping process of wiping the nozzle surface by driving the first moving mechanism so as to move the wiper and the nozzle surface relatively in a direction parallel to the nozzle surface in a state that the wiper and the nozzle surface are brought into contact with each other; and a cleaning process of cleaning the wiper by driving the second moving mechanism so as to move the wiper and the cleaner relatively and bring the wiper and the cleaner into contact with each other. The liquid ejecting apparatus further includes a holding mechanism configured to hold a posture of the wiper during the cleaning process. A pressing force from the cleaner to the wiper in a case where the cleaning process is being executed in a state that the holding mechanism holds the posture of the wiper is greater than a pressing force from the cleaner to the wiper in a case where the cleaning process is being executed in a state that the holding mechanism does not hold the posture of the wiper. In a case where the program causes the liquid ejecting apparatus to execute the first ejecting process under a first condition, the program causes the liquid ejecting apparatus to execute the cleaning process in the state that the holding mechanism holds the posture of the wiper. In a case where the program causes the liquid ejecting apparatus to execute the first ejecting process under a second condition different from the first condition, the program causes the liquid ejecting apparatus to execute the cleaning process in the state that the holding mechanism does not hold the posture of the wiper.

According to the present disclosure, the cleaning can be performed properly by holding the posture of the wiper with the holding member. Further, in a case where the first ejecting process is executed under the first condition, the posture of the wiper is held. On the other hand, in a case where the first ejecting process is executed under the second condition, the posture of the wiper is not held. This can reduce the deterioration of the wiper, as compared with a case where the posture of the wiper is always held during the cleaning process.

### BRIEF DESCRIPTION OF DRAWINGS

FIG. 1 is a plan view of a printer according to an embodiment of the present disclosure.

FIG. 2 is a cross-sectional view of a head included in the printer of FIG. 1.

FIG. 3 is a perspective view of a maintenance unit included in the printer of FIG. 1.

FIG. 4 is a perspective view of the maintenance unit included in the printer of FIG. 1.

FIG. 5 is a perspective view of the maintenance unit included in the printer of FIG. 1.

FIG. 6 is a front view of the maintenance unit included in the printer of FIG. 1.

FIG. 7 is a perspective view of the maintenance unit included in the printer of FIG. 1.

FIG. 8 is a cross-sectional view for illustrating a wiping process in the printer of FIG. 1.

FIG. 9 is a cross-sectional view for illustrating a cleaning process in the printer of FIG. 1.

FIG. 10 is a block diagram depicting the electric configuration of the printer of FIG. 1.

FIG. 11 is a flowchart indicating a program executed by a CPU of the printer of FIG. 1.

FIG. 12 is a plan view of a printer according to another embodiment of the present disclosure.

### DESCRIPTION

### First Embodiment

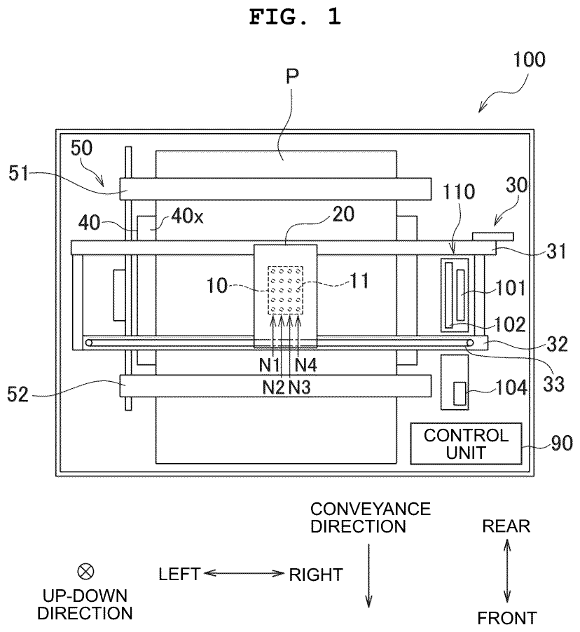

A printer 100 depicted in FIG. 1 is the first embodiment of a “liquid ejecting apparatus” according to the present disclosure. In the following description, the up-down direction is defined with a state that the printer 100 is installed to be usable (the state in FIG. 1) as the reference, the front-rear direction is defined with the downstream side of a conveyance direction of a sheet P as the front side in the front-rear direction, and the left-right direction is defined as viewed from the front surface of the printer 100.

The printer 100 includes an ink-jet head 10 (hereinafter abbreviated as a “head 10”, in some cases) having a plurality of nozzles 11, a carriage 20 which holds the head 10, a moving mechanism 30 which moves the carriage 20 and the head 10 in the left-right direction, a platen 40 which supports the sheet P from below, a conveyor 50 which conveys the sheet P in the conveying direction (frontward), a maintenance unit 110 which performs maintenance of the head 10, and a control unit 90. The sheet P corresponds to a “recording medium” of the present disclosure.

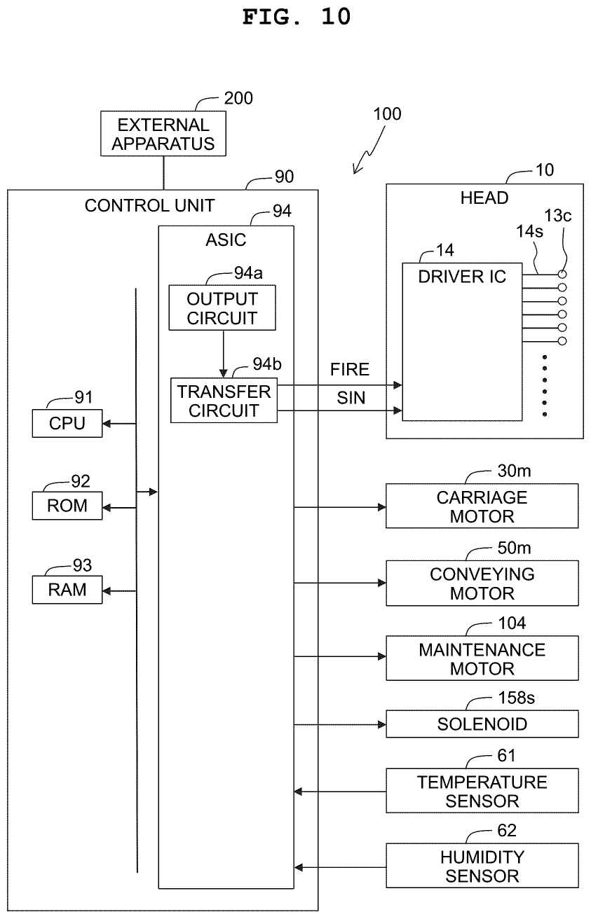

The moving mechanism 30 includes a pair of guides 31 and 32 which supports the carriage 20, and a belt 33 connected to the carriage 20. The pair of guides 31 and 32 and the belt 33 extend in the left-right direction. In a case where a carriage motor 30m (see FIG. 10) is driven under control of the control unit 90, the belt 33 runs so as to move the carriage 20 and the head 10 in the left-right direction along the pair of guides 31 and 32.

The platen 40 is disposed below the carriage 20 and the head 10. The platen 40 corresponds to a “supporting member” of the present disclosure. The upper surface of the platen 40 is a support surface 40x which supports the sheet P.

The conveyor 50 has a roller 51 disposed behind the head 10, and a roller 52 disposed in front of the head 10. The head 10, the carriage 20, and the platen 40 are disposed between the roller 51 and the roller 52 in the front-rear direction.

Each of the rollers 51 and 52 is constructed of a set of rotary members. The set of rotary members includes an upper rotary member disposed above a conveyance route of the sheet P, and a lower rotary member disposed below the conveyance route of the sheet P. The upper rotary member and the lower rotary member are disposed so that the circumferential surfaces thereof are in contact with each other.

In a case where a conveying motor 50m (see FIG. 10) is driven under the control of the control unit 90, the set of rotary members of each of the rollers 51 and 52 rotates. As the set of rotary members of each of the rollers 51 and 52 rotates while holding the sheet P, the sheet P is conveyed in the conveying direction (frontward).

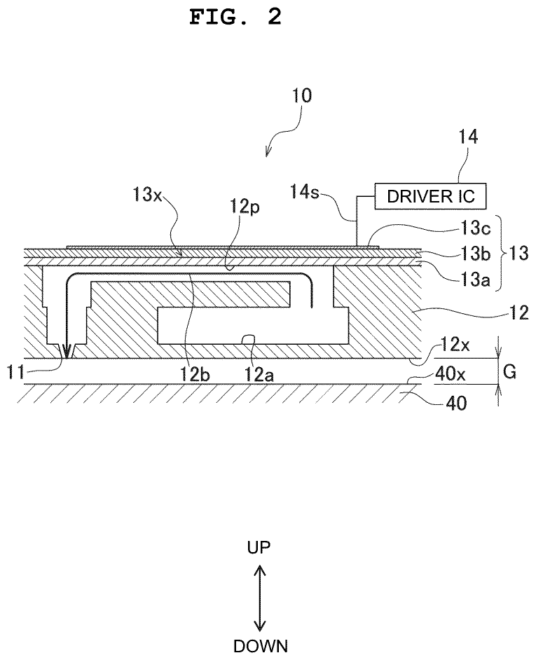

As depicted in FIG. 2, the head 10 includes a channel unit 12 and an actuator unit 13.

The lower surface of the channel unit 12 is a nozzle surface 12x in which the plurality of nozzles 11 are open. The channel unit 12 is disposed above the platen 40 so that a distance G to some extent is defined between the nozzle surface 12x and the support surface 40x.

A common channel 12a which communicates with an ink tank (not depicted in the drawings) and individual channels 12b each of which is individually formed corresponding to one of the nozzles 11 are formed inside the channel unit 12. Each of the individual channels 12b is a channel which extends from an outlet of the common channel 12a and reaches one of the nozzles 12 via a pressure chamber 12p. A plurality of pressure chambers 12p are open in the upper surface of the channel unit 12.

The actuator unit 13 includes a vibration plate 13, a piezoelectric layer 13b and a plurality of individual electrodes 13c. The vibration plate 13a is made of metal and disposed on the upper surface of the channel unit 12 so as to cover the plurality of pressure chambers 12p. The piezoelectric layer 13b is disposed on the upper surface of the vibration plate 13a. Each of the plurality of individual channels 13c is disposed on the upper surface of the piezoelectric layer 13b so as to face a pressure chamber 12b included in the plurality of pressure chambers 12p and corresponding thereto.

The vibration plate 13a and the plurality of individual channels 13c are electrically connected to a driver IC 14. The driver IC 14 maintains the potential of the vibration plate 13a at the ground potential. On the other hand, the driver IC 14 changes the potential of each of the plurality of individual channels 13c. Specifically, the driver IC 14 generates a drive signal based on a control signal (a waveform signal FIRE and a selection signal SIN) from the control unit 90, and supplies the drive signal to each of the plurality of individual channels 13c via a signal line 14s. This causes the potential of each of the plurality of individual channels 13c to change between a predetermined drive potential (VDD) and the ground potential (OV). In this situation, a portion of the vibration plate 13a and a portion of the piezoelectric layer 13b which are sandwiched between each of the plurality of individual electrodes 13c and one of the plurality of pressure chambers 12p corresponding thereto (actuator 13x) are deformed. This changes the volume of the corresponding pressure chamber 12p and applies pressure to an ink in one of the pressure chambers 12p corresponding thereto, causing the head 10 to eject ink from the corresponding nozzle 11. The actuator 13x is disposed as actuators 13 each of which corresponds to one of the individual electrodes 13c (i.e., one of the nozzles 11) and each of which is deformable independently in response to the potential supplied to one of the individual electrodes 13c corresponding thereto.

As depicted in FIG. 1, the plurality of nozzles 11 construct four nozzle rows N1 to N4 disposed side by side in the left-right direction, and each of the four nozzle rows N1 to N4 is constructed of nozzles 11 aligned in the front-rear direction. A black ink is ejected from the nozzles 11 in the nozzle row N1. A cyan ink is ejected from the nozzles 11 in the nozzle row N2. A magenta ink is ejected from the nozzles 11 in the nozzle row N3. A yellow ink is ejected from the nozzles 11 in the nozzle row N4.

The black ink is a pigment ink containing a resin component, and is a liquid (first liquid) from which a solid content precipitates. The resin component is a component causing the pigment to fix to the sheet P, and is, for example, a synthetic resin which exceeds the glass-transition temperature by being heated. On the other hand, each of the color inks (cyan ink, magenta ink and yellow ink) is a dye ink which does not contain a resin component, and is a liquid (second liquid) from which a solid content is less likely to precipitate, as compared with the black ink. Each of the nozzles 11 constructing the nozzle row N1 corresponds to a “first nozzle” of the present disclosure, and each of the nozzles 11 constructing the respective nozzle rows N2 to N4 corresponds to a “second nozzle” of the present disclosure.

As depicted in FIG. 1, the maintenance unit 110 is located to the right of the platen 40. The maintenance unit 110 includes a wiper 101, a cleaner 102 and a maintenance motor 104.

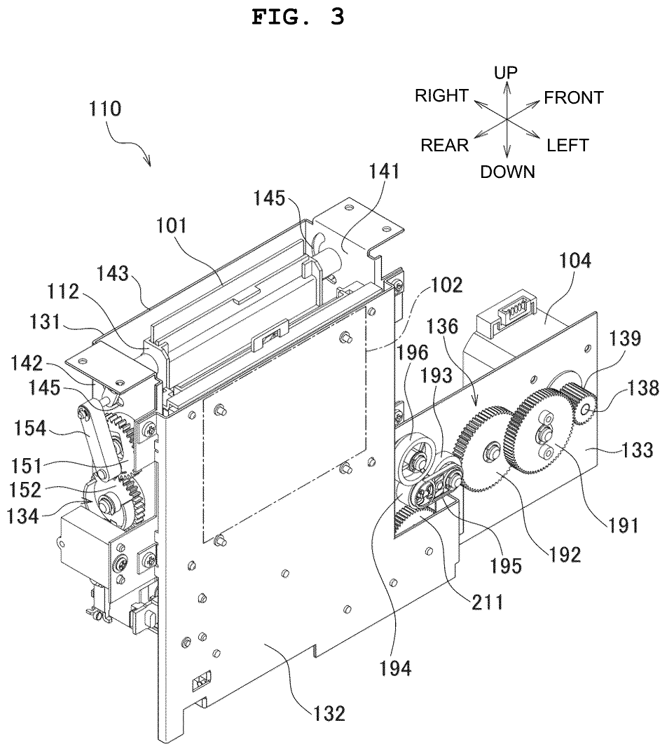

The wiper 101 wipes the nozzle surface 12x (see FIG. 2) to thereby remove the ink adhering to the nozzle surface 12x. For example, the ink adheres to the nozzle surface 12x in a case where the ink is ejected from the nozzles 11 to the sheet P in a recording process. Further, the ink adheres to the nozzle surface 12x in a case where the ink is forcibly discharged from the nozzles 11 in a state that the nozzles 11 are covered with a cap (not depicted in the drawings) in a capping process. The ink adhering to the nozzle surface 12x is removed by the wiper 101. The wiper 101 is a plate-shaped member made of an elastically deformable material such as rubber, etc. The wiper 101 is supported by a frame 131, as depicted in FIG. 3.

The cleaner 102 comes into contact with the wiper 101 to thereby remove the ink adhering to the wiper 101. The cleaner 102 is a member to which a cleaning liquid can be impregnated and which is capable of holding the cleaning liquid. The cleaner 102 is, for example, a resin member in which micropores are formed by foaming. The cleaner 102 is supported by a frame 132, as depicted in FIG. 3.

The maintenance motor 104 is supported by a frame 133 as depicted in FIG. 3.

The frames 131 to 133 are connected to one another. The frame 131 is formed by bending a metal sheet, and has a front wall 141, a rear wall 142 and a side wall 143.

The rotation of the maintenance motor 104 is transmitted to the wiper 101 by a gear train 136 supported by the frame 133 and a gear train 134 supported by the frame 131.

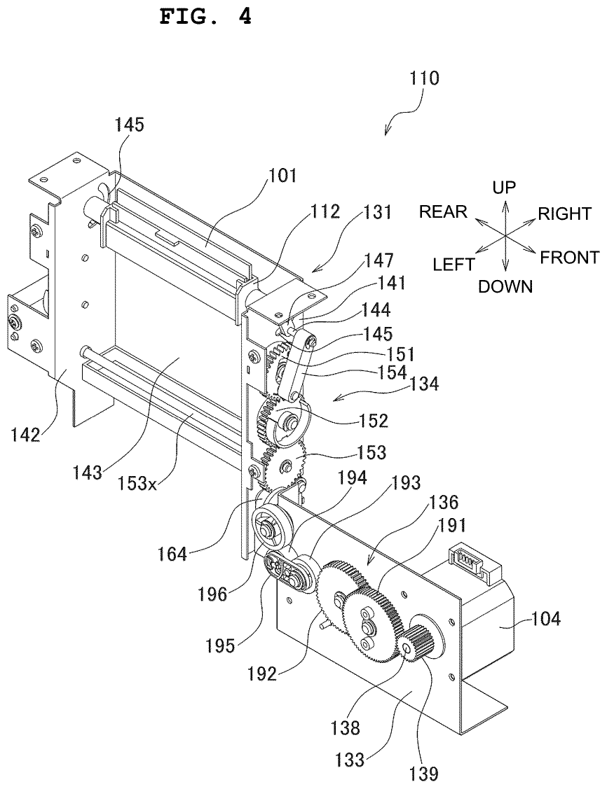

As depicted in FIGS. 3 and 4, the gear train 136 includes a reduction gear 191, a gear 192, a sun gear 193, a planetary gear 194, and a bevel gear 196. The reduction gear 191 meshes with a gear 139 and the gear 192, and transmits the rotation of the gear 139 to the gear 192 at a predetermined reduction ratio. The gear 139 is fixed to an output shaft 138 of the maintenance motor 104. The sun gear 193 meshes with the gear 192. The planetary gear 194 is rotatably supported by a supporting arm 195, and meshes with the sun gear 193. The supporting arm 195 is rotatably connected to the shaft of the sun gear 193. By the rotation of the sun gear 193, the planetary gear 194 can take a position at which the planetary gear 194 meshes with the bevel gear 196 and a position at which the planetary gear 194 does not mesh with the bevel gear 196.

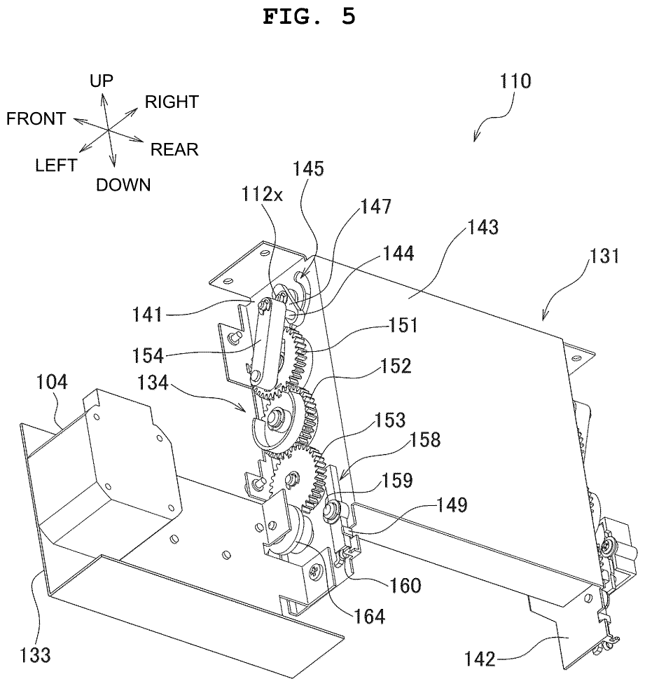

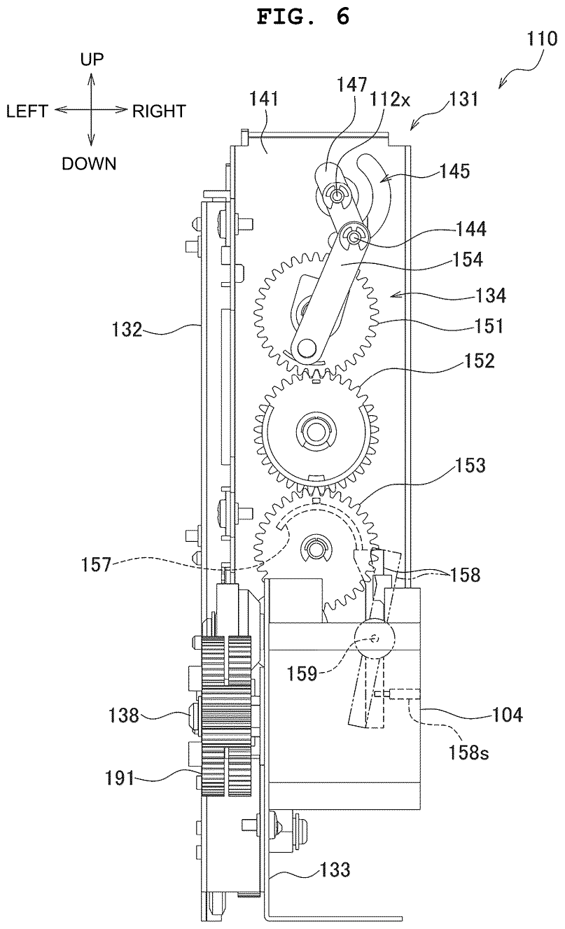

As depicted in FIGS. 3 and 4, the gear train 134 is supported by each of the front wall 141 and the rear wall 142. As depicted in FIGS. 5 and 6, a shaft 112x is inserted through the front wall 141 and the rear wall 142. The shaft 112x is a rotating shaft of a holder 112 (see FIG. 4) which holds the wiper 101, and extends in the front-rear direction. The holder 112 is rotatable about the shaft 112x in a state that the holder 112 holds the wiper 101.

As depicted in FIGS. 3 to 6, a slit 145 is formed in each of the front wall 141 and the rear wall 142. As depicted in FIGS. 4 to 6, an input shaft 144 is inserted into the slit 145. The front end of the input shaft 144 and the front end of the shaft 112x, and the rear end of the input shaft 144 and the rear end of the shaft 112x are connected, respectively, by connecting members 147.

As depicted in FIG. 4, the gear train 134 includes three gears 151, 152 and 153 which mesh in series, and a bevel gear 164. The bevel gear 164 is located below the gear 153 and meshes with the gear 153. A portion, of the gear 151, which is away from the shaft line in the radial direction and the front end of the input shaft 144 are connected by a coupling rod 154. The coupling rod 154 transmits the rotation of the gear 151 as movement of the input shaft 144 inside the slit 145.

The bevel gear 196 of the gear train 136 meshes with the bevel gear 164 of the gear train 134. The bevel gear 196 and the bevel gear 164 mesh with each other to thereby transmit the rotation from the gear train 136 to the gear train 134.

Note that the respective gears of the gear train 134 supported by each of the front wall 141 and the rear wall 142 rotate in synchronization with each other since the gears 153 supported by each of the front wall 141 and the rear wall 142 are connected to each other via a shaft 153x.

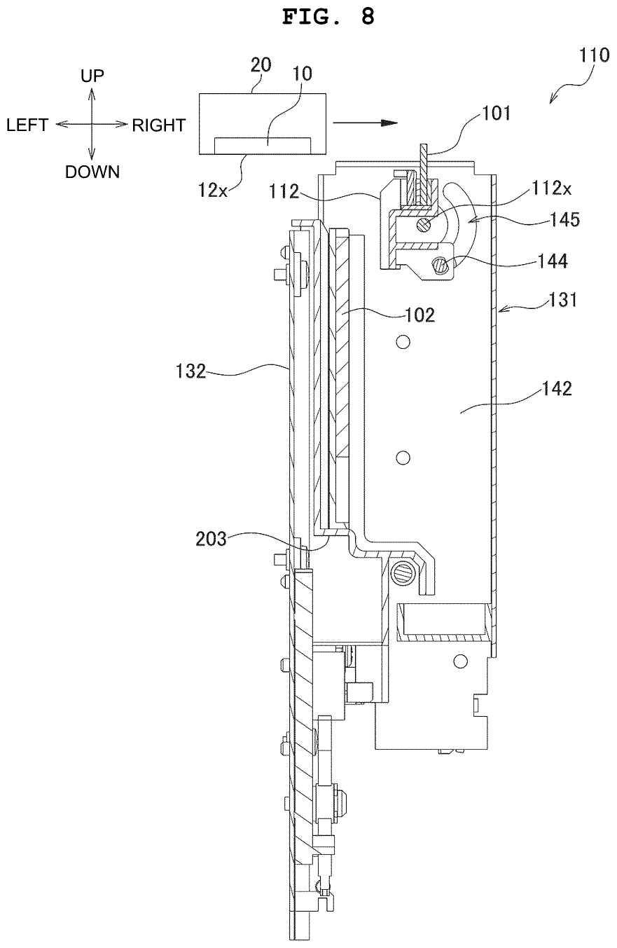

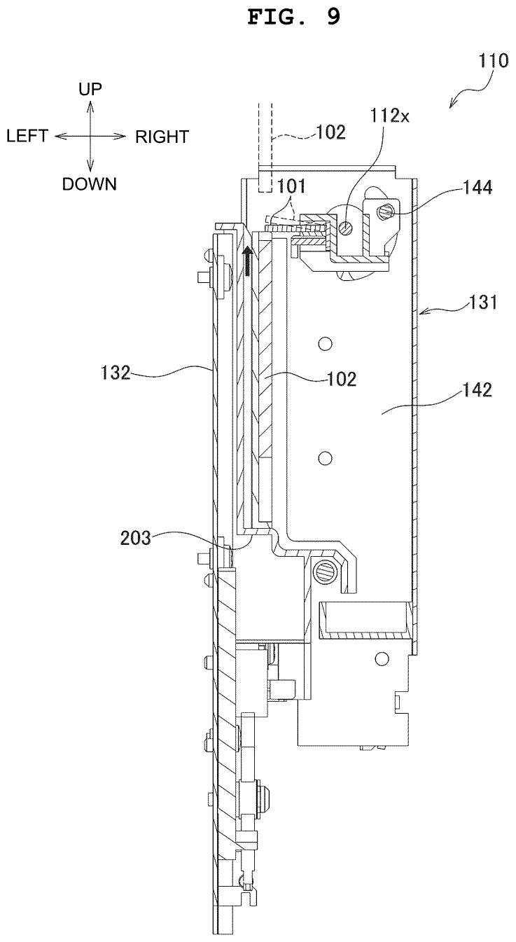

The rotation of the maintenance motor 104 is transmitted to the input shaft 144 by the gear train 134, and the input shaft 144 moves inside the slit 145 to thereby cause the holder 112 to rotate about the shaft 112x in a state that the holder 112 holds the wiper 101. With this, the wiper 101 is capable of taking a first posture depicted in FIG. 8 and a second posture depicted by solid lines in FIG. 9.

In a case where the wiper 101 takes the first posture, as depicted in FIG. 8, the wiper 101 extends in the up-down direction and is capable of coming into contact with the nozzle surface 12x of the head 10 which is being moved in the left-right direction. In the wiping process, the wiper 101 is held in the first posture.

In a case where the wiper 101 takes the second posture, as depicted in FIG. 9, the wiper 101 extends in the left-right direction and cannot come into contact with the nozzle surface 12x (see FIG. 8) of the head 10 which is being moved in the left-right direction. In the cleaning process, the wiper 101 is basically held in the second posture.

In the cleaning process, the cleaner 102 moves upward, in state that the cleaner 102 is held by a holder 203, from a standby position which is below the wiper 101 (position indicated by solid lines in FIG. 9) to a position above the wiper 101 (position indicated by broken lines in FIG. 9). In this situation, the cleaner 102 comes into contact with the tip of the wiper 101, removing the ink adhering to the tip of the wiper 101.

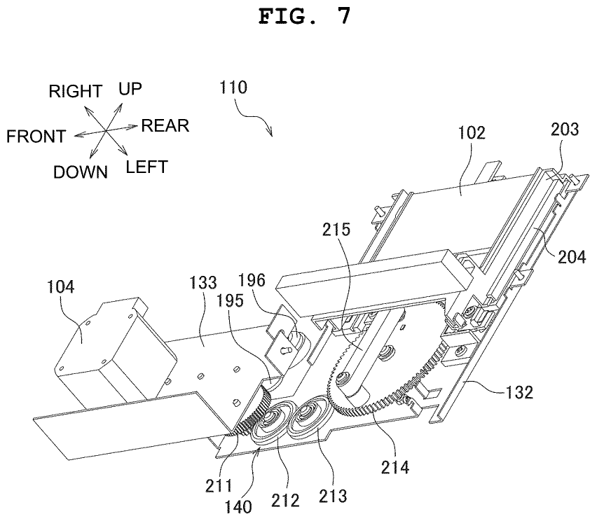

The rotation of the maintenance motor 104 is transmitted to the cleaner 102 by the gear train 136 (see FIGS. 3 and 4) supported by the frame 133 and a gear train 140 (see FIG. 7) supported by the frame 132.

As depicted in FIG. 7, the gear train 140 includes a reduction gear 211 and three gears 212, 213 and 214 which mesh in series with one another. The reduction gear 211 is capable of meshing with the planetary gear 194 (see FIG. 3) of the gear train 136, and also meshes with the gear 212, thereby transmitting the rotation of the planetary gear 194 to the gear 212 at a predetermined reduction ratio. The rotation is transmitted to the gear 214 through the gears 212 and 213.

A portion, of the gear 214, which is separated from the shaft line in the radial direction is connected to a lower end of the holder 203 by a coupling rod 215. The coupling rod 215 transmits the rotation of the gear 214 as movement in the up-down direction of the holder 203. The holder 203 is supported by a guide member 204 disposed in the frame 132 so that the holder 203 is movable in the up-down direction.

In the cleaning process, in a case where the cleaner 102 moves as described above, a force causing the wiper 101 to move from the second posture to the first posture is applied to the wiper 101. That is, in FIG. 9, a force causing the wiper to rotate clockwise about the shaft 112x is applied to the wiper 101. In a case where the posture of the wiper 101 is not held during the cleaning process (for example, in a case where the wiper 101 moves from the second posture in a direction causing the wiper to move from the second posture closely toward the first posture, as depicted by the broken lines in FIG. 9), such a problem that the cleaning is not properly performed might occur.

In order to prevent the above-described problem from occurring, the printer 100 includes a stopper 158 (see FIG. 6) as a holding mechanism configured to hold the posture (second posture) of the wiper 101 during the cleaning process. A pressing force from the cleaner 102 to the wiper 101 in a case where the cleaning process is executed in a state that the stopper 158 holds the posture (second posture) of the wiper 101 (see the solid lines in FIG. 9) is greater than a pressing force from the cleaner 102 to the wiper 101 in a case where the cleaning process is executed in a state that the stopper 158 does not hold the posture (second posture) of the wiper 101 (see the broken lines in FIG. 9).

Further, the printer 100 includes a solenoid 158s as a releasing mechanism configured to release the holding of the posture of the wiper 101 by the stopper 158 (see FIG. 6), from the viewpoint that in a case where the stopper 158 constantly holds the posture (second posture) of the wiper 101 during the cleaning process, the above-described pressing force might promote the deterioration of the wiper 101.

As depicted in FIG. 5, the stopper 158 is disposed to be capable of coming into contact with the gear 153. The stopper 158 is supported by each of the front wall 141 and the rear wall 142. The stopper 158 is supported by the front wall 141 or the rear wall 142 to be rotatable about a shaft 159 extending in the front-rear direction. The stopper 158 is biased counterclockwise as viewed from the front side by a tension spring 160, and the counterclockwise rotation of the stopper 158 is regulated by the lower end of the stopper 158 coming into contact with the abutment wall 149.

The solenoid 158s can be located at a contracted position at which the solenoid 158 is not in contact with the stopper 158, or at an extending position (see broken lines in FIG. 6) at which the solenoid 158 is in contact with the stopper 158, under the control of the control unit 90. In a case where the solenoid 158s is moving from the contracted position to the extending position, the stopper 158 rotates clockwise as viewed from the front side, by being pressed by the solenoid 158s against the urging force of the tension spring 160 (see FIG. 5). As a result, the stopper 158 is located at a retracted position at which the stopper 158 is not in contact with a rib 157 of the gear 153, as depicted by alternate long and short dash lines in FIG. 6.

In a case where the solenoid 158s is located at the contracted position, the stopper 158 may come into contact with the rib 157, as depicted by the solid lines and broken lines in FIG. 6. In a case where the stopper 158 comes into contact with the rib 157, the rotation of the gear 153 (clockwise rotation as viewed from the front side) is regulated. This rotation of the gear 153 is a rotation in a case where the wiper 101 moves from the second posture to the first posture. In this case, the wiper 101 does not move from the second posture to the first posture, but the wiper 101 is held in the second posture.

In a case where the solenoid 158s is located at the extending position, the stopper 158 is located at the retracted position where the stopper 158 does not contact the rib 157, as depicted by the alternate long and short dash lines in FIG. 6. In this case, the rotation of the gear 153 (the rotation in the case where the wiper 101 moves from the second posture to the first posture) is not regulated, and thus the wiper 101 is not held in the second posture and the wiper 101 may move toward the first posture, as depicted by the broken lines in FIG. 9.

As depicted in FIG. 10, the control unit 90 includes a CPU (Central Processing Unit) 91, a ROM (Read Only Memory) 92, a RAM (Random Access Memory) 93, and an ASIC (Application Specific Integrated Circuit) 94. Among these as described above, the CPU 91 and the ASIC 94 correspond to a “controller” of the present disclosure.

The ROM 92 stores a program and/or data to be used in a case where the CPU 91 and/or the ASIC 94 perform(s) a variety of kinds of control. The RAM 93 temporarily stores data (image data, etc.) to be used in a case where the CPU 91 and/or the ASIC 94 execute(s) the program. The control unit 90 is communicably connected to an external apparatus (a personal computer, etc.) 200. The control unit 90 executes a process related to recording of image, a process related to maintenance of the head 10, etc., by the CPU 91 and/or the ASIC 94 based on data input from the external apparatus 200 or an input part of the printer 100 (a switch and/or button disposed in the outer surface of the casing of the printer 100).

As depicted in FIG. 10, the ASIC 94 includes an output circuit 94a and a transfer circuit 94b.

The output circuit 94a generates a waveform signal FIRE and a selection signal SIN, and outputs the waveform signals FIRE and the selection signal SIN to the transfer circuit 94b for each recording period. The recording period is a time required for the sheet P to move relative to the head 10 by a unit distance corresponding to the resolution of an image to be formed on the sheet P, and corresponds to one pixel.

The waveform signal FIRE is a serial signal which is obtained by serializing four waveform data. The four waveform data correspond, respectively, to the volumes of an ink droplet to be ejected from the nozzle 11 in one recording period which are “zero (no ejection)”, “small”, “middle”, and “large”, and the four waveform data have mutually different pulse numbers.

The waveform signal SIN is a serial signal including selection data for selecting one of the four waveform data, and is generated for each of the plurality of actuators 13x and for each recording period, based on image data included in a recording instruction.

The transfer circuit 94b transfers the waveform signal FIRE and the selection signal SIN received from the output circuit 94a to the driver IC 14. The transfer circuit 94b has built-in LVDS drivers (Low Voltage Differential Signaling drivers) each corresponding to one of the waveform signal FIRE and the selection signal SIN, and transfers each of the waveform signal FIRE and the selection signal SIN to the driver IC 14 as a pulse-shaped differential signal.

In the recording process, the ASIC 94 controls the driver IC 14 so as to generate the drive signal based on the waveform signal FIRE and the selection signal SIN for each pixel, and supplies the drive signal to each of the plurality of individual electrodes 13c via the signal line 14s. As a result, the ASIC 94 causes each of the plurality of nozzles 11 to eject an ink droplet of a volume selected from the four kinds of volumes (zero, small, middle and large) toward the sheet P, for each pixel.

The control unit 90 is further electrically connected to the carriage motors 30m, the conveying motor 50m, the maintenance motor 104 and the solenoid 158s, and controls the driving of each of these motors 30m, 50m, 104 and the solenoid 158s. Further, the control unit 90 is electrically connected to a temperature sensor 61 and a humidity sensor 62. The temperature sensor 61 detects the environmental temperature of the wiper 101 and transmits a signal indicating the environmental temperature to the control unit 90. The humidity sensor 62 detects the environmental humidity of the wiper 101 and transmits a signal indicating the environmental humidity to the control unit 90. The temperature sensor 61 and the humidity sensor 62 are disposed inside the casing of the printer 100.

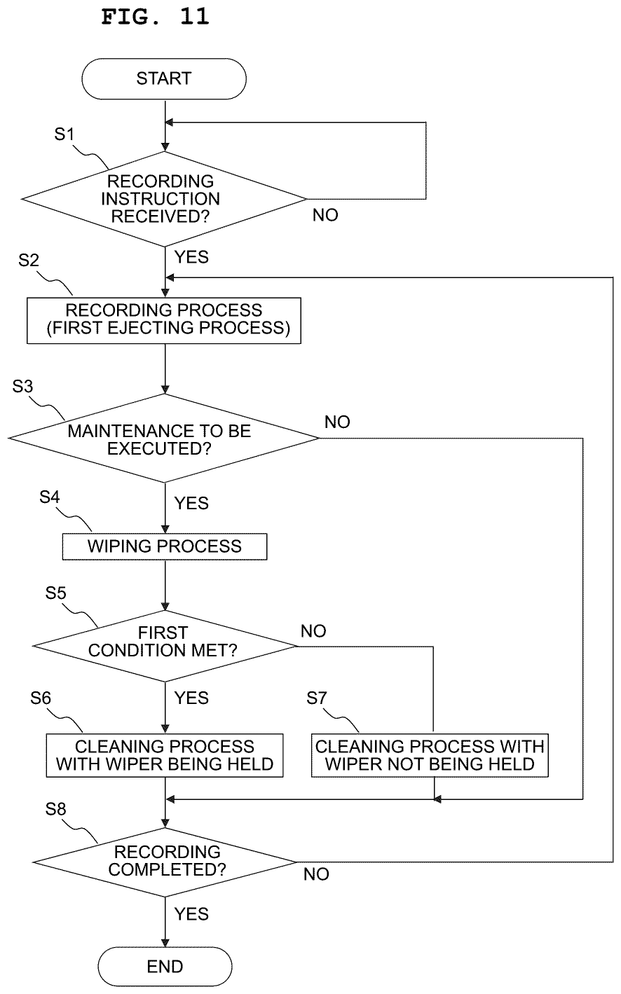

Next, a program executed by the CPU 91 will be described with reference to FIG. 11.

At the start of the program, the wiper 101 takes the second posture (posture depicted by solid lines in FIG. 9), and the cleaner 102 is located at the standby position (position depicted by solid lines in FIG. 9).

The CPU 91 firstly determines whether or not the CPU 91 has received the recording instruction from the external apparatus 200, etc. (step S1).

In a case where the CPU 91 determines that the CPU 91 has not received the recording instruction (step S1: NO), the CPU 91 repeats the process of step S1.

In a case where the CPU 91 determines that the CPU 91 has received the recording instruction (step S1: YES), the CPU 91 controls the driver IC 14, the carriage motor 30m and the conveying motor 50m (see FIG. 10) via the ASIC 94 based on the image data included in the recording instruction received in step S1, thereby starting the recording process (step S2). In the recording process, a scanning operation of ejecting the ink from the plurality of nozzles 11 onto the sheet P while causing the carriage 20 and the head 10 to move in the left-right direction, and a conveying operation of conveying the sheet P forward by a predetermined amount are alternately performed. As a result, dots of the inks are formed on the sheet P, and an image is recorded on the sheet P.

In the recording process, the CPU 91 causes the head 10 to eject ink from the nozzles 11 to the sheet P by driving the actuators 13x. The recording process corresponds to a “first ejecting process” of the present disclosure.

After step S2, the CPU 91 determines whether or not to execute the maintenance (step S3). This determination is made after the start of the recording process and before the completion of the recording process. For example, the CPU 91 determines to execute the maintenance in a case where a predetermined time has elapsed after the start of the recording process or after the above-described capping process.

In a case where the CPU 91 determines not to execute the maintenance (step S3: NO), the CPU 91 advances the process to step S8.

In a case where the CPU 91 determines to execute the maintenance (step S3: YES), the CPU 91 executes the wiping process (step S4).

In the wiping process, the CPU 91 firstly causes the maintenance motor 104 to rotate in the forward direction so as to rotate the wiper 101 via the gear trains 136 and 134, thereby causing the wiper 101 to take the first posture (the posture depicted in FIG. 8). Then, the CPU 91 causes the carriage motor 30m to rotate so as to drive the moving mechanism 30, thereby moving the carriage 20 and the head 10 rightward in a state that the wiper 101 is held in the first posture. In this situation, the nozzle surface 12x moves while being in contact with the tip of the wiper 101. As a result, the ink adhering to the nozzle surface 12x is removed by the wiper 101.

The wiping process is a process of wiping the nozzle surface 12x. In the wiping process, the moving mechanism 30 causes the wiper 101 and the nozzle surface 12x to move relative to each other in a direction parallel to the nozzle surface 12x (the left-right direction) in a state that the wiper 101 and the nozzle surface 12x are brought into contact with each other. The moving mechanism 30 corresponds to a “first moving mechanism” of the present disclosure.

After step S4, the CPU 91 determines whether or not a first condition is met (i.e., whether or not the recording process started in step S2 is executed under the first condition) (step S5).

The recording process is performed under either the first condition or a second condition different from the first condition. The first condition is a condition that the ink adhering to the wiper 101 is removed less easily as compared with the second condition.

For example, in a case where the CPU 91 executes a previous cleaning process before the cleaning process and the CPU 91 does not execute another cleaning process between the previous process and the cleaning process, the first condition may be a condition that an ejection amount of the ink from the nozzle 11 after completion of the previous cleaning process exceeds a predetermined amount. The predetermined amount is, for example, an amount derived from the resolution of the head 10 and the size of the sheet P, and may be an ink amount equivalent to solid printing.

Further, as will be described later, the cleaning process includes a cleaning process (step S6) which is executed in a state that the stopper 158 is caused to hold the posture (second posture) of the wiper 101, and a cleaning process (step S7) which is executed in a state that the stopper 158 is not caused to hold the posture (second posture) of the wiper 101. The previous cleaning process may be the cleaning process of step S6.

The first condition may be a condition that the ink ejected from the nozzle 11 is a liquid from which a solid content precipitates (black ink). The CPU 91 may determine that the recording process is executed under the first condition in a case where the ink is ejected only from the nozzles 11 constructing the nozzle row N1 in the recording process, or may determine that the recording process is executed under the first condition in a case where the ink is ejected not only from the nozzles 11 constructing the nozzle row N1 but also from the nozzles 11 constructing the nozzle rows N2 to N4 in the recording process.

The first condition may be a condition that the ratio of the ejection amount of the ink (black ink) from the nozzles 11 constructing the nozzle row N1 to the ejection amount of the ink (color ink) from the nozzles 11 constructing the nozzle rows N2 to N4 exceeds a predetermined value (e.g., 1).

The first condition may be a condition that the environmental temperature of the wiper 101 is equal to or higher than a first predetermined temperature (e.g., 30 degrees Celsius), or a condition that the environmental temperature of the wiper 101 is equal to or lower than a second predetermined temperature (e.g., 18 degrees Celsius).

The environmental temperature is determined by the CPU 91 based on a signal from the temperature sensor 61. The CPU 91 may determine the environmental temperature by performing calculation, etc., based on the signal from the temperature sensor 61 (e.g., a signal indicating a voltage value or an electric current value).

The first condition may be a condition that the environmental humidity of the wiper 101 is equal to or lower than a predetermined humidity (e.g., 50%).

The environmental humidity is determined by the CPU 91 based on a signal from the humidity sensor 62. The CPU 91 may determine the environmental humidity by performing calculation, etc., based on the signal from the humidity sensor 62 (e.g., a signal indicating a voltage value or an electric current value).

The first condition may be a condition that the volume of the ink droplet ejected from the nozzle 11 is less than a predetermined volume (for example, “middle” among the above-described four kinds of volumes (zero, small, middle and large)). The CPU 91 may determine that the recording process is executed under the first condition in a case where an ink droplet with a “small” volume is ejected in the recording process, or the CPU 91 may determine that the recording process is executed under the first condition in a case where the average of the volumes of the ink droplets ejected in the recording process is less than “middle”.

The first condition may be a condition that the ejection velocity of the ink droplet from the nozzle 11 is less than a predetermined velocity. In a case where the ejection velocity is not constant in the recording process and where the average of the ejection velocities in the recording process is less than the predetermined velocity, the CPU 91 may determine that the recording process is executed under the first condition.

The first condition may be a condition that the distance G (see FIG. 2) between the nozzle surface 12x and the support surface 40x is equal to or greater than a predetermined distance.

The first condition may be a condition that the following expression is satisfied. Regarding each of “V” and “S” in the expression, the average value thereof in the recording process may be used:

V×S/G<35
(in the expression, V: volume [pL] of the ink droplet ejected from the nozzle 11, S: ejection velocity [m/s] of the ink droplet from the nozzle 11, G: distance [mm] between the nozzle surface 12x and the support surface 40x).

The first condition may be a condition that the ejection duty of the nozzle 11 exceeds a predetermined value (for example, 75%). The ejection duty means the ratio of an actual ejection amount to a required ejection amount based on the image data included in the recording instruction.

The first condition in each of the above-described examples may be a condition after the previous cleaning process is completed.

In a case where the CPU 91 determines that the first condition is met (i.e., the recording process is executed under the first condition) (step S5: YES), the CPU 91 executes the cleaning process in a state that the stopper 158 holds the posture (second posture) of the wiper 101 (step S6).

In a case where the CPU 91 determines that the first condition is not met (i.e., the recording process is executed under the second condition) (step S5: NO), the CPU 91 executes the cleaning process in a state that the stopper 158 does not hold the posture (second posture) of the wiper 101 (step S7).

In step S6 and step S7, the CPU 91 firstly causes the motor 30m to rotate so as to drive the moving mechanism 30, thereby locating each of the carriage 20 and the head 10 at a position not overlapping with the maintenance unit 110 in the up-down direction. Then, the CPU 91 causes the maintenance motor 104 to rotate in the forward direction while holding the solenoid 158s at the contracted position in step S6 and holding the solenoid 158s at the extending position in step S7. This causes the wiper 101 to rotate via the gear trains 136 and 134, thereby causing the wiper 101 to move from the first posture (the posture depicted in FIG. 8) to the second posture (the posture depicted by the solid lines in FIG. 9). Then, the CPU 91 causes the maintenance motor 104 to rotate in the reverse direction, thereby causing the cleaner 102 to move upward via the gear trains 136 and 140 from the standby position (the position depicted by the solid lines in FIG. 9) to the position above the wiper 101 (the position depicted by the broken lines in FIG. 9). In this situation, the cleaner 102 comes into contact with the wiper 101, thereby applying, to the wiper 101, a force causing the wiper 101 to move from the second posture to the first posture. However, in step S6, the stopper 158 comes into contact with the rib 157 as depicted by the solid lines and broken lines in FIG. 6, and thus the wiper 101 is not caused to move from the second posture to the first posture and is held in the second posture. On the other hand, in step S7, the stopper 158 is located at the retracted position as depicted by the alternate long and short dash lines in FIG. 6, and thus the rotation of the gear 153 (the rotation in the case where the wiper 101 is caused to move from the second posture to the first posture) is not regulated. Therefore, the wiper 101 is not held in the second posture and may move toward the first posture as depicted by the broken lines in FIG. 9.

In step S6 and step S7, the cleaner 102 moves while making contact with the tip of the wiper 101. As a result, the ink adhering to the tip of the wiper 101 is removed by the cleaner 102.

The cleaning process is the process of driving the gear trains 136 and 140 so as to move the wiper 101 and the cleaner 102 relatively and bring the wiper 101 and the cleaner 102 into contact with each other, thereby cleaning the wiper 101. The gear trains 136 and 140 are mechanisms configured to move the wiper 101 and the cleaner 102 relative to each other, and correspond to a “second moving mechanism” of the present disclosure.

After step S6 or step S7, the CPU 91 determines whether or not the recording based on the recording instruction is completed (step S8).

In a case where the CPU 91 determines that the recording is not completed (step S8: NO), the CPU 91 returns the process to step S2.

In a case where the CPU 91 determines that the recording is completed (step S8: YES), the CPU 91 ends the program.

As described above, according to the present embodiment, the appropriate cleaning can be realized by holding the posture of the wiper 101 with the stopper 158. Further, in a case where the recording process is executed under the first condition, the posture of the wiper 101 is held (step S6). On the other hand, in a case where the recording process is executed under the second condition, the posture of the wiper 101 is not held (step S7). With this, the deterioration of the wiper 101 can be prevented, as compared to a case where the posture of the wiper 101 is always held during the cleaning process.

For example, the first condition may be a condition that the ejection amount of the ink from the nozzle 11 after completion of the previous cleaning process exceeds a predetermined amount. In a case where the recording process is executed under the condition that the ejection amount exceeds the predetermined amount, the ink adhering to the wiper 101 cannot be easily removed. In such a case, the ink adhering to the wiper 101 can be efficiently removed by executing the cleaning process in the state that the posture of the wiper 101 is held.

The previous cleaning process may be the cleaning process of step S6 which is executed in a state that the posture of the wiper 101 is held by the stopper 158. In a case where the cleaning process is executed in the state that the posture of the wiper 101 is held, the ink adhering to the wiper 101 is removed more efficiently than in a case where the cleaning process is executed in a state that the posture of the wiper 101 is not held. Therefore, by determining the first condition based on the ejection amount, with the former case as the reference, the cleaning according to the amount of the ink adhering to the wiper 101 can be appropriately executed.

The first condition may be the condition that the ink ejected from the nozzle 11 is the liquid from which the solid content precipitates (the black ink). In a case where the liquid from which the solid content precipitates adheres to the wiper 101, the liquid cannot be easily removed from the wiper 101. In such a case, by performing the cleaning process in the state that the posture of the wiper 101 is held, the liquid adhering to the wiper 101 can be efficiently removed.

The plurality of nozzles 11 includes the first nozzle (which is each of the nozzles 11 constructing the nozzle row N1) ejecting the first liquid from which the solid content precipitates (the black ink), and the second nozzle (which is each of the nozzles 11 constructing the nozzle rows N2 to N4) ejecting the second liquid (which is one of the color inks (cyan, magenta and yellow inks)) from which the solid content is less likely to precipitate than the first liquid. In this case, the two kinds of liquids can be selectively ejected. As a result, various images can be recorded on the sheet P.

The first condition may be a condition that the ratio of the ejection amount of the ink (black ink) from the nozzles 11 constructing the nozzle row N1 to the ejection amount of the ink (color ink) from the nozzles 11 constructing the nozzle rows N2 to N4 exceeds the predetermined value. Since the solid content of the black ink is more likely to precipitate than the solid content of the color ink, in a case where the ratio exceeds the predetermined value, the ink adhering to the wiper 101 cannot be removed easily. In such a case, the ink adhering to the wiper 101 can be efficiently removed by executing the cleaning process in the state that the posture of the wiper 101 is held.

The predetermined value may be 1. In this case, the ink adhering to the wiper 101 can be removed efficiently.

The first condition may be a condition that the environmental temperature of the wiper 101 is equal to or higher than the first environmental temperature (e.g., 30 degrees Celsius). As the environmental temperature of the wiper 101 becomes higher, the drying of the ink adhering to the wiper 101 is promoted further, and a solid matter of the ink generated by the drying cannot be easily removed from the wiper 101. Therefore, in a case where the environmental temperature is equal to or higher than the first environmental temperature, the ink and/or the solid matter adhering to the wiper 101 can be efficiently removed by executing the cleaning process in the state that the posture of the wiper 101 is held.

The first condition may be a condition that the environmental temperature of the wiper 101 is equal to or lower than the second environmental temperature (e.g., 18 degrees Celsius). As the environmental temperature of the wiper 101 becomes lower, the viscosity of the ink is further lowered, and the ink adhering to the wiper 101 cannot be easily removed. Further, in order to eject the ink with a low viscosity, the deformation amount of the actuator 13x needs to be increased. As the deformation amount of the actuator 13x is greater, the ejection velocity becomes faster, thereby allowing a large amount of the ink to easily adhere to the nozzle surface 12x. In this case, the amount of the ink adhering to the wiper 101 is also increased, making the ink adhering to the wiper 101 harder to remove. In this regard, in a case where the environmental temperature is equal to or lower than the second environmental temperature, the ink adhering to the wiper 101 can be efficiently removed by executing the cleaning process in the state that the posture of the wiper 101 is held.

The first condition may be a condition that the environmental humidity of the wiper 101 is equal to or lower than the predetermined humidity (e.g., 50%). As the environmental humidity of the wiper 101 becomes lower, the drying of the ink adhering to the wiper 101 is further promoted, and the solid matter of the ink generated by the drying cannot be easily removed from the wiper 101. In this regard, in a case where the environmental humidity is equal to or lower than the predetermined humidity, the ink and/or the solid matter adhering to the wiper 101 can be efficiently removed by executing the cleaning process in the state that the posture of the wiper 101 is held.

The first condition may be a condition that the volume of the ink droplet ejected from the nozzle 11 is less than the predetermined volume. As the volume of the ink droplet is smaller, the ink droplet becomes further lightweight, due to which the ink droplet is more likely to float in the air and to adhere to the nozzle surface 12x. As a result, the amount of the ink adhering to the wiper 101 is increased, and thus the ink adhering to the wiper 101 cannot be easily removed. In this regard, in a case where the volume of the ink droplet is less than the predetermined volume, the ink adhering to the wiper 101 can be efficiently removed by executing the cleaning process in the state that the posture of the wiper 101 is held.

The first condition may be a condition that the ejection velocity of the ink droplet from the nozzle 11 is less than the predetermined velocity. As the ejection velocity of the ink droplet is lower, the ink droplet is more likely to float in the air and to adhere to the nozzle surface 12x. As a result, the amount of the ink adhering to the wiper 101 is increased, and thus the ink adhering to the wiper 101 cannot be easily removed. In this regard, in a case where the ejection velocity of the ink droplet is less than the predetermined velocity, the ink adhering to the wiper 101 can be efficiently removed by executing the cleaning process in the state that the posture of the wiper 101 is held.

The first condition may be a condition that the distance G (see FIG. 2) between the nozzle surface 12x and the support surface 40x is equal to or greater than the predetermined distance. As the distance G, is greater, the ink droplet ejected from the nozzle 11 is more likely to float in the air and to adhere to the nozzle surface 12x. As a result, the amount of the ink adhering to the wiper 101 is increased, and thus the ink adhering to the wiper 101 cannot be easily removed. In this regard, in a case where the distance G is equal to or greater than the predetermined distance, the ink adhering to the wiper 101 can be efficiently removed by executing the cleaning process in the state that the posture of the wiper 101 is held.

The first condition may be a condition that the following expression is satisfied:

$$V \times S / G < 35$$

(in the expression, V: the volume [pL] of the ink droplet ejected from the nozzle 11, S: the ejection velocity [m/s] of the ink droplet from the nozzle 11, and G: the distance [mm] between the nozzle surface 12x and the support surface 40x). In a case where the above-described expression is satisfied, the ink ejected from the nozzle 11 is likely to float in the air and to adhere to the nozzle surface 12x. As a result, the amount of the ink adhering to the wiper 101 is increased, and thus the ink adhering to the wiper 101 cannot be easily removed. In this regard, in a case where the above-described expression is satisfied, the ink adhering to the wiper 101 can be efficiently removed by executing the cleaning process in the state that the posture of the wiper 101 is held.

The first condition may be a condition that the ejection duty of the nozzle 11 exceeds the predetermined value. As the ejection duty becomes higher, the ink is more likely to adhere to the nozzle surface 12x. As a result, the amount of the ink adhering to the wiper 101 is increased, and thus the ink adhering to the wiper 101 is harder to remove. In this regard, in a case where the ejection duty exceeds the predetermined value, the ink which adheres to the wiper 101 can be efficiently removed by executing the cleaning process in the state that the posture of the wiper 101 is held.

### Second Embodiment

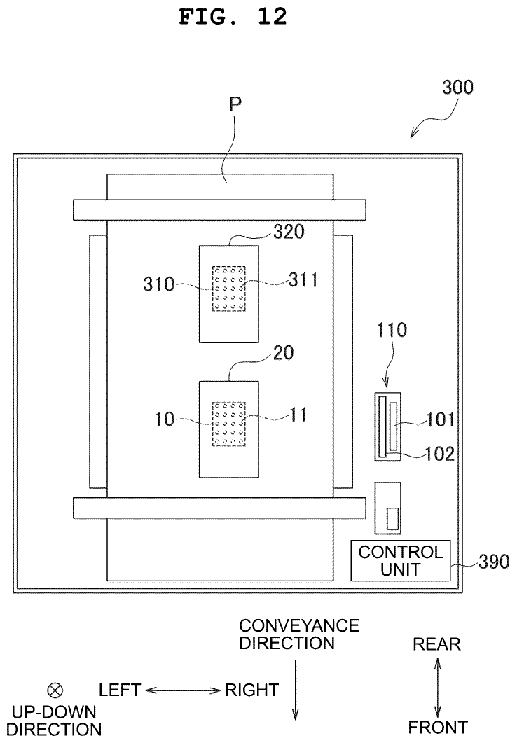

A printer 300 depicted in FIG. 12 is the second embodiment of the “liquid ejecting apparatus” according to the present disclosure. The differences between the printer 300 and the printer 100 will be described below.

The printer 300 includes a treatment liquid-ejecting head 310 (hereinafter abbreviated as a “head 310”, in some cases), in addition to the ink-jet head 10. The head 310 corresponds to a “treatment liquid-ejecting part” of the present disclosure.

The head 310 has a configuration similar to the configuration of the head 10. The head 310 has a plurality of nozzles 311, and is movable in the left-right direction while being held by a carriage 320 by a moving mechanism similar to the moving mechanism 30 (see FIG. 1). In FIG. 12, the moving mechanism of the head 310 is omitted from the illustration.

The head 310 is disposed behind (upstream in the conveyance direction of) the head 10. A pre-treatment liquid is ejected from the plurality of nozzles 311. The pre-treatment liquid is a treatment liquid which is volatile and which reacts with the ink to solidify the ink.

After a CPU of a controller 390 receives a recording instruction (step S1: YES), the CPU of the controller 390 determines, before the recording process of step S2 is started and based on image data included in the recording instruction, whether or not to execute a process (second ejecting process) of causing the head 310 to eject the pre-treatment liquid to the sheet P before the head 10 is caused to eject the ink to the sheet P in the recording process of step S2. That is, the recording process of step S2 (first ejecting process) can include the second ejecting process.

In a case where the CPU of the controller 390 determines that the second ejecting process is to be executed in the recording process of step S2, the CPU controls the movement of each of the carriage 20 and the carriage 320 and the ejection from each of the head 10 and the head 310 so that the pre-treatment liquid lands on the sheet P before the ink lands on the sheet P in the recording process of step S2. In a case where the CPU determines that the second ejecting process is not to be executed in the recording process of step S2, the CPU executes a process similar to the process executed under the first embodiment, without causing the head 310 to eject the pre-treatment liquid in the recording process of step S2.

In the second embodiment, the first condition may be a condition that the recording process of step S2 includes the above-described process (second ejecting process). In a case where the volatile treatment liquid reacts with the ink adhering to the wiper 101 and the ink solidifies on the wiper 101, the ink and/or the solid matter cannot be easily removed from the wiper 101. In this regard, in a case where the recording process S2 includes the above-described process (second ejecting process), the ink and/or the solid matter adhering to the wiper 101 can be efficiently removed by executing the cleaning process in the state that the posture of the wiper 101 is held.

### Modifications

Although the embodiments of the present disclosure have been described above, the present disclosure is not limited to the above-described embodiments, and various design changes are possible within the scope of the claims.

In the above-described embodiments, although the stopper 158 is described as an example of the holding mechanism, the holding mechanism is not limited to this. For example, the holding mechanism may be an electromagnetic valve which holds the holder 112 and/or the gear 153 and stops the operation of the holder 112 and/or the gear, etc.

The wiper is not limited to having a configuration which rotates, and may have a configuration wherein the wiper is movable in the vertical direction, etc. For example, in a configuration wherein the solenoid is driven to thereby move the wiper in the vertical direction, and the wiper may move in the vertical direction by the pressing force from the cleaner in a case where the solenoid is in an ON state; on the other hand, the wiper does not move in the vertical direction in a case where the wiper receives the pressing force from the cleaner and where the solenoid is in an OFF state, the holding mechanism may hold the posture of the wiper by maintaining the solenoid in the OFF state.

The second moving mechanism is not limited to rotating the wiper and/or moving the cleaner in the vertical direction as long as the second moving mechanism causes the wiper and the cleaner to move relative to each other.

In the above-described embodiment, although the black ink (pigment ink containing a resin component) is described as an example of the liquid from which the solid content precipitates, the liquid is not limited to this and may be made of any material as long as a solid content precipitates from the liquid over time.

In the second embodiment, although the head 310 which ejects the pre-treatment liquid is exemplified, a head which ejects a post-treatment liquid may be adopted, instead of the head 310. The post-treatment liquid is a treatment liquid which is volatile and which reacts with the ink and solidifies the ink, similar to the pre-treatment liquid. In this case, the second ejecting process is a process in which the post-treatment liquid is ejected to the recording medium after the ink has been ejected.

Although the head is of the serial system in the above-described embodiments, the head may be of the line system.

The liquid ejected from the nozzle is not limited to the ink, and may be a liquid other than the ink, for example, a treatment liquid which agglutinates or precipitates a component in an ink.

The recording medium is not limited to a sheet, but may be, for example, cloth, a resin member, etc.

The program according to the present disclosure can be distributed in a state that the program is stored in a removable storage medium such as a flexible disc, or a fixed storage medium such as a hard disc, or may be distributed via a communication line.

The present disclosure is not limited to being applicable to printers, and is applicable also to facsimiles, copying machines, multi-function peripherals, etc. Further, the present disclosure is applicable also to a liquid ejecting apparatus for any usage other than the image recording. For example, the present disclosure is applicable also to a liquid ejecting apparatus which ejects a conductive liquid to a substrate so as to form a conductive pattern.

What is claimed is:

1. A liquid ejecting apparatus comprising:
a head having a nozzle surface and an actuator, the nozzle surface having a nozzle opened therein, the actuator being configured to cause liquid to be ejected from the nozzle;
a wiper;
a cleaner;
a first moving mechanism configured to move the nozzle surface and the wiper relatively;
a second moving mechanism configured to move the wiper and the cleaner relatively; and
a controller,
wherein the controller being configured to execute:
a first ejecting process of ejecting the liquid from the nozzle to a recording medium by driving the actuator;
a wiping process of wiping the nozzle surface by driving the first moving mechanism so as to move the wiper and the nozzle surface relatively in a direction parallel to the nozzle surface in a state that the wiper and the nozzle surface are brought into contact with each other; and
a cleaning process of cleaning the wiper by driving the second moving mechanism so as to move the wiper and the cleaner relatively and bring the wiper and the cleaner into contact with each other,
the liquid ejecting apparatus further comprising a holding mechanism configured to hold a posture of the wiper during the cleaning process,
a pressing force from the cleaner to the wiper in a case where the controller executes the cleaning process in a state that the holding mechanism holds the posture of the wiper is greater than a pressing force from the cleaner to the wiper in a case where the controller executes the cleaning process in a state that the holding mechanism does not hold the posture of the wiper,
in a case where the controller executes the first ejecting process under a first condition, the controller is configured to execute the cleaning process in the state that the holding mechanism holds the posture of the wiper, and
in a case where the controller executes the first ejecting process under a second condition different from the first condition, the controller is configured to execute the cleaning process in the state that the holding mechanism does not hold the posture of the wiper.

2. The liquid ejecting apparatus according to claim 1, wherein in a case where the controller executes a previous cleaning process before the cleaning process, and the controller does not execute another cleaning process between the previous cleaning process and the cleaning process, the first condition is a condition that an amount of the liquid ejected from the nozzle after completion of the previous cleaning process exceeds a predetermined amount.

3. The liquid ejecting apparatus according to claim 2, wherein the previous cleaning process is the cleaning process executed in the state where the holding mechanism holds the posture of the wiper.

4. The liquid ejecting apparatus according to claim 1, wherein the first condition is a condition that a solid content precipitates from the liquid ejected from the nozzle.

5. The liquid ejecting apparatus according to claim 1, wherein
nozzles including the nozzle are open in the nozzle surface,
the nozzles include a first nozzle configured to eject a first liquid, and a second nozzle configured to eject a second liquid,
a solid content precipitates from the first liquid, and
the solid content is less likely to precipitate from the second liquid than from the first liquid.

6. The liquid ejecting apparatus according to claim 5, wherein the first condition is a condition that a ratio of an ejection amount of the first liquid from the first nozzle to an ejection amount of the second liquid from the second nozzle exceeds a predetermined value.

7. The liquid ejecting apparatus according to claim 6, wherein the predetermined value is 1.

8. The liquid ejecting apparatus according to claim 1, further comprising a temperature sensor configured to detect environmental temperature of the wiper,
wherein the first condition is a condition that the environmental temperature is equal to or higher than a first predetermined temperature.

9. The liquid ejecting apparatus according to claim 1, further comprising a temperature sensor configured to detect environmental temperature of the wiper,
wherein the first condition is a condition that the environmental temperature is equal to or lower than a second predetermined temperature.

10. The liquid ejecting apparatus according to claim 1, further comprising a humidity sensor configured to detect environmental humidity of the wiper,
wherein the first condition is a condition that the environmental humidity is equal to or lower than a predetermined humidity.

11. The liquid ejecting apparatus according to claim 1, wherein the first condition is a condition that a volume of a liquid droplet ejected from the nozzle is less than a predetermined volume.

12. The liquid ejecting apparatus according to claim 1, wherein the first condition is a condition that ejection velocity of a liquid droplet ejected from the nozzle is less than a predetermined velocity.

13. The liquid ejecting apparatus according to claim 1, further comprising a supporting member having a support surface configured to support the recording medium,
wherein the first condition is a condition that a distance between the nozzle surface and the support surface is equal to or greater than a predetermined distance.

14. The liquid ejecting apparatus according to claim 1, further comprising a supporting member having a support surface configured to support the recording medium,
wherein the first condition is a condition that the following expression is satisfied:
$$V \times S / G < 35$$
(wherein V: volume [pL] of a liquid droplet ejected from the nozzle, S: ejection velocity [m/s] of the liquid droplet from the nozzle, and G: distance [mm] between the nozzle surface and the support surface).

15. The liquid ejecting apparatus according to claim 1, wherein the first condition is a condition that ejection duty of the nozzle exceeds a predetermined value.

16. The liquid ejecting apparatus according to claim 1, further comprising a treatment liquid-ejecting part configured to eject a treatment liquid, wherein
the treatment liquid is volatile and reacts with the liquid to solidify the liquid, and
the first condition is a condition that the first ejecting process includes a second ejecting process of ejecting the treatment liquid from the treatment liquid-ejecting part either before or after the liquid is ejected to the recording medium.

17. A control method of a liquid ejecting apparatus including: a head having a nozzle surface and an actuator, the nozzle surface having a nozzle opened therein, the actuator being configured to cause liquid to be ejected from the nozzle; a wiper; a cleaner; a first moving mechanism configured to move the nozzle surface and the wiper relatively; and a second moving mechanism configured to move the wiper and the cleaner relatively, the control method comprising:
a first ejecting process of ejecting the liquid from the nozzle to a recording medium by driving the actuator;
a wiping process of wiping the nozzle surface by driving the first moving mechanism so as to move the wiper and the nozzle surface relatively in a direction parallel to the nozzle surface in a state that the wiper and the nozzle surface are brought into contact with each other; and
a cleaning process of cleaning the wiper by driving the second moving mechanism so as to move the wiper and the cleaner relatively and bring the wiper and the cleaner into contact with each other,
wherein the liquid ejecting apparatus further including a holding mechanism configured to hold a posture of the wiper during the cleaning process,
a pressing force from the cleaner to the wiper in a case where the cleaning process is being executed in a state that the holding mechanism holds the posture of the wiper is greater than a pressing force from the cleaner to the wiper in a case where the cleaning process is being executed in a state that the holding mechanism does not hold the posture of the wiper,
in a case where the first ejecting process is executed under a first condition, the cleaning process is executed in the state that the holding mechanism holds the posture of the wiper, and
in a case where the first ejecting process is executed under a second condition different from the first condition, the cleaning process is executed in the state that the holding mechanism does not hold the posture of the wiper.

18. A non-transitory medium storing a program for a liquid ejecting apparatus, the liquid ejecting apparatus including: a head having a nozzle surface and an actuator, the nozzle surface having a nozzle opened therein, the actuator being configured to cause liquid to be ejected from the nozzle; a wiper; a cleaner; a first moving mechanism configured to move the nozzle surface and the wiper relatively; and a second moving mechanism configured to move the wiper and the cleaner relatively, the program causing the liquid ejecting apparatus to execute:
a first ejecting process of ejecting the liquid from the nozzle to a recording medium by driving the actuator;
a wiping process of wiping the nozzle surface by driving the first moving mechanism so as to move the wiper and the nozzle surface relatively in a direction parallel to the nozzle surface in a state that the wiper and the nozzle surface are brought into contact with each other; and
a cleaning process of cleaning the wiper by driving the second moving mechanism so as to move the wiper and the cleaner relatively and bring the wiper and the cleaner into contact with each other,
wherein the liquid ejecting apparatus further including a holding mechanism configured to hold a posture of the wiper during the cleaning process,
a pressing force from the cleaner to the wiper in a case where the cleaning process is being executed in a state that the holding mechanism holds the posture of the wiper is greater than a pressing force from the cleaner to the wiper in a case where the cleaning process is being executed in a state that the holding mechanism does not hold the posture of the wiper,
in a case where the program causes the liquid ejecting apparatus to execute the first ejecting process under a first condition, the program causes the liquid ejecting apparatus to execute the cleaning process in the state that the holding mechanism holds the posture of the wiper, and
in a case where the program causes the liquid ejecting apparatus to execute the first ejecting process under a second condition different from the first condition, the program causes the liquid ejecting apparatus to execute the cleaning process in the state that the holding mechanism does not hold the posture of the wiper.
